(19) United States
(12) Patent Application Publication
(10) Pub. No.: US 2014/0240871 A1
(43) Pub. Date: Aug. 28, 2014

(54) INTERFACE VOLTAGE CONTROL OPERATING POINT DETERMINATION IN A HARD DISK DRIVE

(71) Applicant: HGST NETHERLANDS B.V., Amsterdam (NL)

(72) Inventors: Sripathi Vangipuram Canchi, San Jose, CA (US); John Thomas Contreras, Palo Alto, CA (US); Saurabh Deoras, Milpitas, CA (US); Samir Y. Garzon, Sunnyvale, CA (US); Remmelt Pit, Menlo Park, CA (US)

(73) Assignee: HGST NETHERLANDS B.V., Amsterdam (NL)

(21) Appl. No.: 13/781,352

(22) Filed: Feb. 28, 2013

(51) Int. Cl. G11B 21/21

(52) U.S. Cl. CPC G11B 21/21
USPC 360/234.5

(57) ABSTRACT

Approaches for an interface voltage control (IVC) system in a hard-disk drive (HDD), whereby the IVC operating point determination scheme utilizes non-contact spacing signals for calibration of IVC. While applying a series of input voltages to a slider, head-disk spacing signals are monitored, such as spacing signals from an embedded contact sensor or Wallace spacing loss spacing signals. Based on the relation between the spacing signal values and the series of input voltages, the IVC operating point is identified and stored within the HDD. The IVC operating point corresponds to the IVC input voltage necessary to neutralize the natural slider-disk voltage potential that would otherwise cause an electrostatic force that pulls the slider closer to the disk and can cause lubrication transfer from disk to slider.

### FIELD OF THE INVENTION

Embodiments of the invention relate generally to an interface voltage control (IVC) system in a hard-disk drive (HDD) and, more specifically, to calibrating the IVC system.

### BACKGROUND

A hard-disk drive (HDD) is a non-volatile storage device that is housed in a protective enclosure and stores digitally encoded data on one or more circular disks having magnetic surfaces (a disk may also be referred to as a platter). When an HDD is in operation, each magnetic-recording disk is rapidly rotated by a spindle system. Data is read from and written to a magnetic-recording disk using a read/write head which is positioned over a specific location of a disk by an actuator.

A read/write head uses a magnetic field to read data from and write data to the surface of a magnetic-recording disk. As a magnetic dipole field decreases rapidly with distance from a magnetic pole, the distance between a read/write head, which is housed in a slider, and the surface of a magnetic-recording disk must be tightly controlled. An actuator relies in part on a suspension's force on the slider and on the aerodynamic characteristics of the slider air bearing surface (ABS) to provide the proper distance between the read/write head and the surface of the magnetic-recording disk (the “flying height”) while the magnetic-recording disk rotates. A slider therefore is to “fly” over the surface of the magnetic-recording disk.

Flying height control systems are used to fly the read/write head as close as possible to the magnetic-recording disk for effective operation of the head. Typically, such systems gently urge the head area of the slider toward the disk until contact is made (“touchdown”) at which point the slider is urged away from the disk (“pull-back”). However, the act of contacting the disk causes mechanical wear of the head which, over time, often leads to operational degradation and eventually failure. Additionally, touchdown measurements are relatively time consuming and, consequently, are not practical to perform for each head-disk interlace in an HDD and/or over the life of the HDD to detect changing interface conditions.

IVC (Interface Voltage Control) is used to apply a voltage to the slider body, or to the disk. In some instances, IVC may be used to passivate the slider by encapsulating at least a portion of the slider body with a static electrical charge, which can help preserve the life of the slider and corresponding read/write head by protecting it from mechanical wear (such as a sloughing off of electrons) as well as from chemical oxidation. Further, in some instances IVC may be used to minimize the slider-disk potential differences. When the slider-disk potential is not cancelled completely, an attractive electrostatic force pulls the slider close to the disk and risks attracting lubrication from the disk onto the slider. However, effective calibration and use of an IVC system requires some awareness of the flying height, which, as mentioned above, can be a deleterious procedure for the read/write head when using a method based on contact/touchdown.

### SUMMARY OF EMBODIMENTS OF THE INVENTION

Embodiments of the invention are directed towards an interface voltage control (IVC) system in a hard-disk drive (HDD). The IVC operating point determination scheme utilizes spacing signals for calibration and use of IVC, rather than relying on the typical touchdown-pullback process described previously in the context of flying height control systems.

While applying a series of input voltages to the slider, head-disk spacing signals, which correspond with the flying height, are monitored. For example, spacing signals from an embedded contact sensor are monitored, or spacing changes calculated using the Wallace spacing loss equation (which is based on the magnetic read back signal) are monitored. Based on the relation between the spacing signal values and the series of input voltages, the IVC operating point is identified, and stored within the HDD for future use. The IVC operating point corresponds to the IVC input voltage necessary to negate, i.e., to neutralize, the natural slider-disk voltage potential which would otherwise cause an electrostatic force that pulls the slider closer to the disk.

The described IVC operating point determination scheme can be completed so quickly, in comparison with prior procedures such as the touchdown-pullback method, that it can be performed for each of multiple head-disk interfaces within an HDD. Furthermore, in view of its rapidity and its relatively benign nature, the described IVC operating point determination scheme can be implemented for utilization on a periodic basis throughout the operating lifecycle of an HDD, to recalibrate the IVC system as HDD internal operating conditions change over time.

Embodiments discussed in the Summary of Embodiments of the Invention section are not meant to suggest, describe, or teach all the embodiments discussed herein. Thus, embodiments of the invention may contain additional or different features than those discussed in this section.

### BRIEF DESCRIPTION OF THE DRAWINGS

Embodiments of the invention are illustrated by way of example, and not by way of limitation, in the figures of the accompanying drawings and in which like reference numerals refer to similar elements and in which;

FIG. 1 is a plan view of an HDD, according to an embodiment of the invention;

FIG. 2 is an illustration of an electrical circuit pathway within an HDD, according to an embodiment of the invention;

FIG. 3A is an illustration of head-disk interface (HDI) without interlace voltage control (IVC) operational, according to an embodiment of the invention;

FIG. 3B is an illustration of head-disk interface (HDI) with IVC operational, according to an embodiment of the invention;

FIG. 4 is a flow diagram illustrating a method for calibrating an IVC system in an HDD, according to an embodiment of the invention: and

FIG. 5 is a graph illustrating IVC operational point estimation using ECS, according to an embodiment of the invention.

### DETAILED DESCRIPTION

Approaches to utilizing spacing signals for calibration and use of an interface voltage control (IVC) system, are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form in order to avoid unnecessarily obscuring the embodiments of the invention described herein.

### Physical Description of Illustrative Embodiments of the Invention

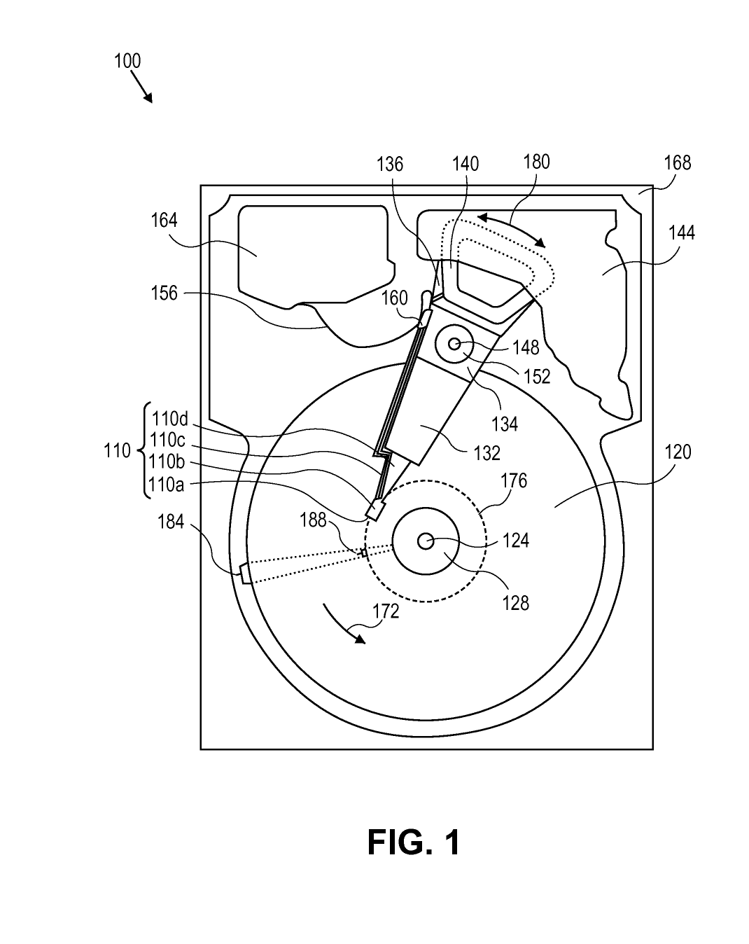

Embodiments of the invention may be used to determine an interlace voltage control (IVC) operating point within a hard-disk drive (HDD). In accordance with an embodiment of the invention, a plan view of a HDD 100 is shown in FIG. 1. FIG. 1 illustrates the functional arrangement of components of the HDD including a slider 110b that includes a magnetic-reading/recording head 110a at a distal end of the slider 110b. Collectively, slider 110b and head 110a may be referred to as a head slider. The HDD 100 includes at least one head gimbal assembly (HGA) 110 including the head slider, a lead suspension 110c attached to the head slider, and a load beam 110d attached to the lead suspension 110c. The HDD 100 also includes at least one magnetic-recording disk 120 rotatably mounted on a spindle 124 and a drive motor (not shown) attached to the spindle 124 for rotating the disk 120. The head 110a includes a write element and a read element for respectively writing and reading information stored on tire disk 120 of the HDD 100. The disk 120 or a plurality (not shown) of disks may be affixed to the spindle 124 with a disk damp 128.

The HDD 100 further includes an arm 132 attached to the HGA 110, a carriage 134, a voice-coil motor (VCM) that includes an armature 136 including a voice coil 140 attached to the carriage 134; and a stator 144 including a voice-coil magnet (not shown). The armature 136 of the VCM is attached to the carriage 134 and is configured to move the arm 132 and the HGA 110 to access portions of the disk 120 being mounted on a pivot-shaft 148 with an interposed pivot-hearing assembly 152. In the ease of an HDD having multiple disks, or platters as disks are sometimes referred to in the art, the carriage 134 is called an “E-block,” or comb, because the carriage is arranged to carry a ganged array of arms that gives it the appearance of a comb.

With further reference to FIG. 1, in accordance with an embodiment of the present invention, electrical signals, for example, current to the voice coil 140 of the VCM, write signal to and read signal from the head 110a, are provided by a flexible interconnect cable 156 (“flex cable”). Interconnection between the flex cable 156 and the head 110a may be provided by an arm-electronics (AE) module 160, which may have an on-board pre-amplifier for the read signal, as well as other read-channel and write-channel electronic components. The AE 160 may be attached to the carriage 134 as shown. The flex cable 156 is coupled to an electrical-connector block 164, which provides electrical communication through electrical feedthroughs (not shown) provided by an HDD housing 168. The HDD housing 168, also referred to as a casting, depending upon whether the HDD housing is cast, in conjunction with an HDD cover (not shown) provides a sealed, protective enclosure for the information storage components of the HDD 100.

With feather reference to FIG. 1, in accordance with an embodiment of the present invention, other electronic components (not shown) including a disk controller and servo electronics including a digital-signal processor (DSP), provide electrical signals to the drive motor, the voice coil 140 of the VCM and the head 110a of the HGA 110. The electrical signal provided to the drive motor enables the drive motor to spin providing a torque to the spindle 124 which is in turn transmitted to the disk 120 that is affixed to the spindle 124 by the disk clamp 128; as a result, the disk 120 spins in a direction 172. The spinning disk 120 creates a cushion of air that acts as an air-bearing on which the air-bearing surface (ABS) of the slider 110b rides so that the slider 110b flies above the surface of the disk 120 without making contact with a thin magnetic-recording medium of the disk 120 in which information is recorded.

The electrical signal provided to the voice coil 140 of the VCM enables the head 110a of the HGA 110 to access attack 176 on which information is recorded. Thus, the armature 136 of the VCM swings through an arc 180 which enables the head 110a on the HGA 110, which is attached to the armature 136 by the arm 132, to access various tracks on the disk 120. Information is stored on the disk 120 in a plurality of concentric tracks (not shown) arranged in sectors on the disk 120, for example, sector 184. Correspondingly, each track is composed of a plurality of sectored track portions, for example, sectored track portion 188. Bach sectored track portion 188 is composed of recorded data and a header containing a servo-burst-signal pattern, for example, an ABCD-servo-burst-signal pattern, information that identities the track 176, and error correction code information. In accessing the track 176, the read element of the head 110a of the HGA 110 reads the servo-burst-signal pattern which provides a position-error-signal (PES) to the servo electronics, which controls the electrical signal provided to the voice coil 140 of the VCM, enabling the head 110a to follow the neck 176. Upon finding the track 176 and identifying a particular sectored track portion 188, the head 110a either reads data from the track 176 or writes data to the track 176 depending on instructions received by the disk controller from an external agent, for example, a microprocessor of a computer system.

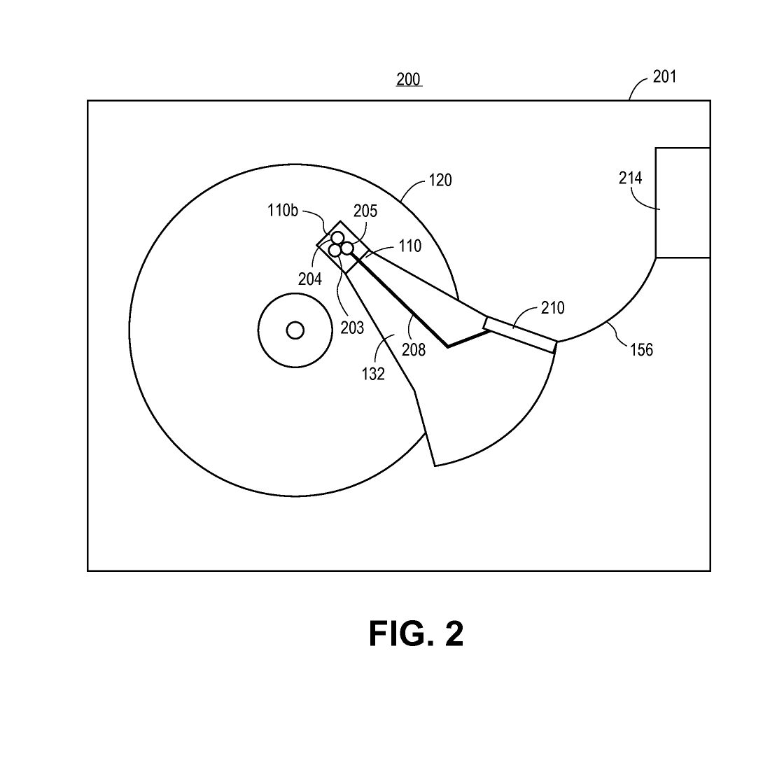

FIG. 2 is an illustration of an electrical circuit pathway within an HDD, according to an embodiment of the invention. FIG. 2 depicts hard-disk drive (HDD) 200 which includes enclosure 201 that contains one or more magnetic platters or disks 120, an embedded contact sensor (ECS) element 203, a read element 204, a write element 205, an actuator arm 132, an HGA 110, a transmission line interconnect 208, an integrated circuit (IC) 210 (such as AE 160), a flexible interconnect cable, and a disk enclosure connector 214.

Electrical signals are communicated between the read/write/ECS elements 203, 204, 205 and integrated circuit 210 over transmission line interconnect 208. Integrated circuit 210 conditions the electrical signals so that they can drive write element 205 during writing and amplifies the electrical signal from read element 204 during reading. Further, IC 210 handles signals to and from ECS 203, which can be utilized as head-disk spacing signals and other flying height signals associated with the control and management of the flying height, generally, and with the IVC system, specifically. Signals are communicated between IC 210 and disk enclosure connector 214 over flex cable 156. Disk enclosure connector 214 conducts signals with circuitry external to disk enclosure 201. In other embodiments, IC 210 is located elsewhere than where depicted in FIG. 2, such as on flex cable 156 or on a printed circuit board (PCB) within the hard-disk drive. IC 210 is at times also referred to as, or may contain, a preamplifier (“preamp”).

### Embedded Contact Sensor

Resistor temperature detector (RTD) systems have been used to determine when the slider head makes physical contact with the magnetic-recording disk based upon the temperature of an element, such as an embedded contact sensor (ECS), embedded in the slider near the read/write head. ECS elements sense physical contact of the slider with the disk based on the ECS element's resistance, e.g., the amount of voltage across the element, which is affected by the temperature change caused by such physical contact.

With further reference to FIG. 2, HD 200 comprises an embedded contact sensor (ECS) 203, according to an embodiment. An ECS 203 is a metallic strip located at the slider 110b (FIG. 1) ABS and typically in close proximity to the write element 205. The resistance of the ECS changes in response to temperature changes and can be used to determine touchdown, when the slider 110b temperature suddenly increases due to frictional heating with the disk 120.

Additionally, ECS can be used to sense flying height variations and for continuous flying height monitoring, U.S. patent application Ser. No. 13/722,935 (“the '935 application”) filed on Dec. 20, 2012 and entitled “Media Topography Driven Flying Height Modulation Sensing Using Embedded Contact Sensor”, is incorporated by reference in its entirety for all purposes as if fully set forth herein. The '935 application describes utilization of an ECS to sense flying height variations and for continuous flying height monitoring at the HDD level, by characterizing the media topography at various Eying heights. Thus, this disk topography data can be used for awareness of the flying height in view of the current ECS value, and is non-destructive in that the slider need not experience repeated touchdowns with the disk.

### Interface Voltage Control System

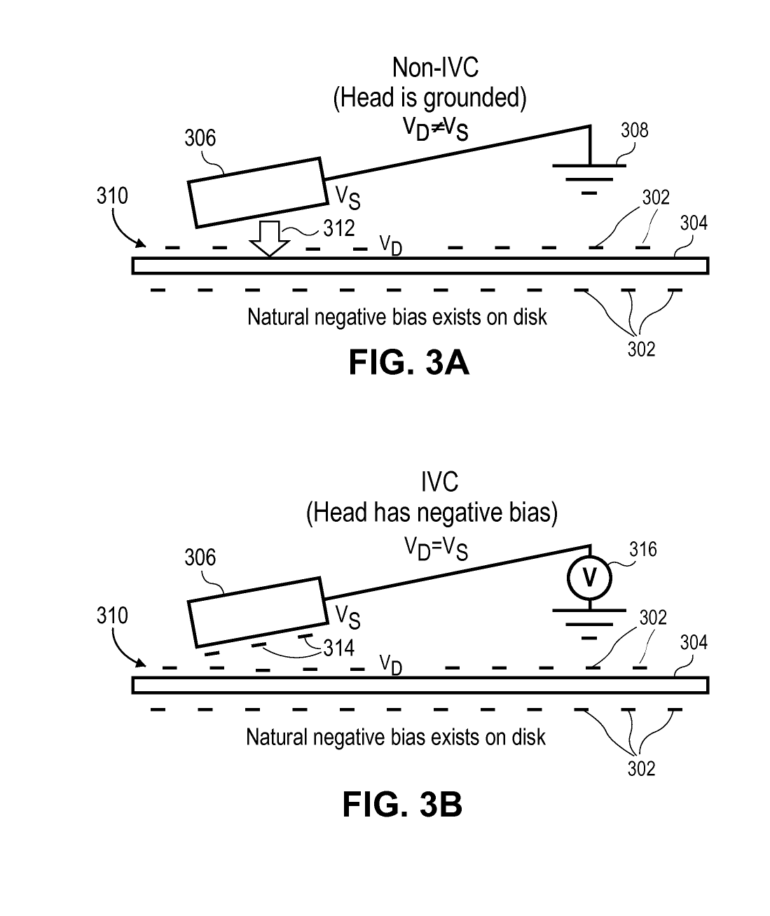

As mentioned, IVC may be used in some instances to minimize the slider-disk potential differences. FIG. 3A is an illustration of head-disk interface (HDI) without IVC operational, according to an embodiment of the invention. FIG. 3A illustrates that a natural negative bias 302 exists on a disk 304. This inherent negative bias 302 is caused, for example, by the nature of the disk materials including carbon coating, the disk lubrication, and the like. In a non-IVC operational state, a slider 306 is grounded, depicted by ground symbol 308. Thus, there is a natural electrical potential difference, or voltage, between the slider 306 and the disk 304 at head-disk interface 310 (V_{D}≠V_{S}). This potential difference manifests as an attractive electrostatic force between the slider 306 and the disk 304, represented by block arrow 312. When the slider-disk potential is not cancelled completely, the slider is pulled closer to the disk, and can cause transfer of lubrication from the disk to the slider, which affects the flying stability of the slider over the disk.

FIG. 3B is an illustration of head-disk interface (HDI) with IVC operational, according to an embodiment of the invention. FIG. 3B illustrates the presence of the natural negative bias 302 existing on the disk 304. However, in an IVC operational state, a small electrical charge 314 is applied to or near the disk-side of the slider 306, depicted as voltage 316. Ideally, electrical charge 314 is equal to negative bias 302, which cancels the slider-disk potential at head-disk interface 310 (V_{D}=V_{S}) and, therefore, negates the attractive electrostatic force that would otherwise be caused by the potential difference between the slider 306 and the disk 304.

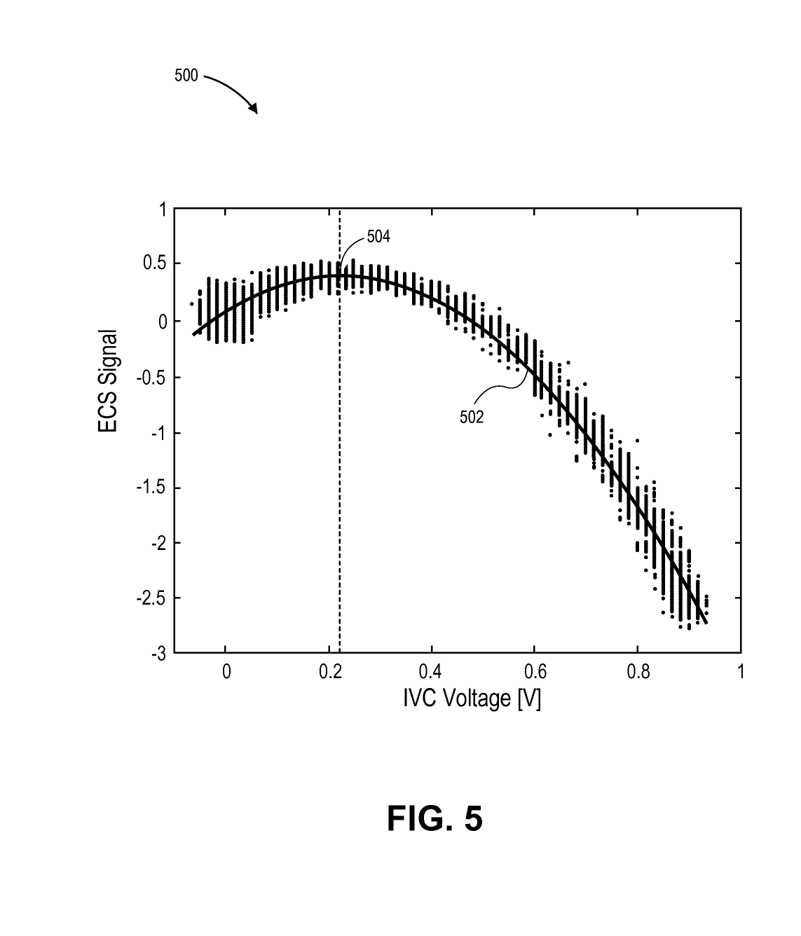

A challenge remains, however, in determining how much electrical charge 314 to apply to the slider 306 to completely neutralized the attractive electrostatic force. If too much voltage 316 or too little voltage 316 is applied to the slider 306, then the electrostatic force is not completely neutralized and some unwanted attraction between the slider 306 and the disk 304 remains. This phenomenon is illustrated in FIG. 5.

### Interface Voltage Control Operating Point Determination

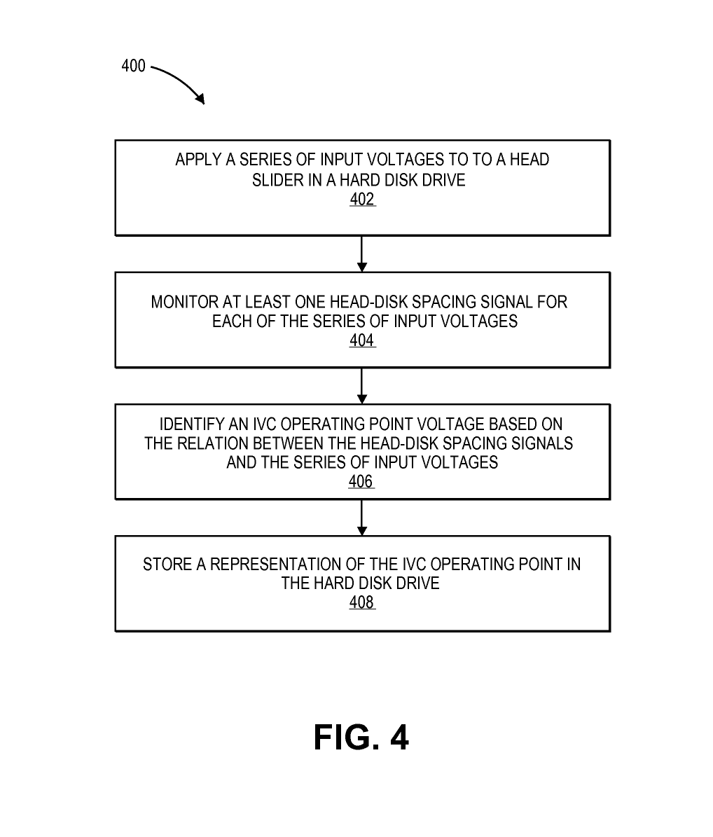

FIG. 4 is a flow diagram illustrating a method for calibrating an interface voltage control (IVC) system in an HDD, according to an embodiment of the invention. The method depicted in FIG. 4 may be implemented for operation by for non-limiting examples, an HDD preamplifier, hard disk controller electronics, read-channel electronics, write-channel electronics, and the like. The method logic may be implemented as firmware or in hardware circuitry, as non-limiting examples.

At block 402, a series of input voltages is applied to a head slider of the HDD. For example, integrated circuit 210 (FIG. 2) initiates, or sweeps through, a series of input voltages which are applied to the slider over transmission line interconnect 208. According to an embodiment, the series of input voltages is transmitted to the ECS element 203 (FIG. 2). However, other electrical elements or leads in the slider may be used for this purpose.

At block 404, at least one head-disk spacing signal is monitored for each of the series of input voltages. The head-disk spacing signals relate to corresponding flying heights, thus, the flying height is implicitly monitored based on head-disk spacing signals rather than based on slider touchdown/pullback operations. According to one embodiment, the head-disk spacing signals on which the flying heights implicitly correspond include head-disk spacing signals from the ECS 203 (FIG. 2) located in the slider 110b. In this embodiment, the signal from the ECS is used as a proxy for a spacing signal, as it is not a per se spacing signal because it requires a calibration with corresponding flying height for use as a flying height determinant. However, uncalibrated ECS signals are referred to as, and serve the purpose of, spacing signals as described and used herein.

According to one embodiment, the head disk spacing signals on which the flying heights correspond include head-disk spacing signals based on the Wallace spacing loss. The Wallace spacing loss relationship, also referred to as dual harmonic sensing (DHS), is known in the art for its use in flying height measurement. With the Wallace spacing loss relationship, the change in amplitude of the measured read-back signal harmonies directly relate to the flying height change of the read/write head/transducer. By calculating the ratio of the fundamental amplitude, Va, and 3rd harmonic amplitude, Vb, the FH is derived from the following expression;

In Vₐ/V_{b}=4nd/₂,

where:

2=velocity/_{write frequency,}

and
d=the head-to-disk spacing.

Additional information regarding in-situ measurement of transducer/recording medium clearance is described in U.S. Pat. No, 5,130,866 to Klaassen et al., the content of which is incorporated by reference in its entirety for all purposes as if fully set forth herein.

FIG. 5 is a graph illustrating IVC operational point estimation using ECS, according to an embodiment of the invention. The graph 500 of FIG. 5 depicts raw data, as well as a 2^{nd} order fit, for IVC disk voltages (V) along the x-axis in relation to ECS response signals along the y-axis. With further reference to FIG. 4, blocks 402 and 404 provide data that can be characterized similarly to the data shown in FIG. 5. That is, applying a series of voltages to the slider (e.g., the ECS element 203 of FIG. 2), and monitoring and/or measuring head-disk spacing signals for each of the input voltages (e.g., spacing signals from the ECS element 203), results in data as represented in the graph of FIG. 5.

With further reference to FIG. 4, at block 406, an IVC operating point voltage is identified based on the relation between the head-disk spacing signals (implicitly, the corresponding flying heights) and the series of input voltages. With further reference to the data depicted in FIG. 5, the peak 504 of the curve 502 represents the IVC operating point (also referred to as the “null-point”), which refers to the amount of voltage inherent to the disk and, therefore, the amount of voltage (0.22 V in this example) that needs to be applied to the head slider in order to fully negate the natural attractive electrostatic force between the two bodies (see bias 302 of FIGS. 3A and 3B). Note that with this technique, it is not necessary to calibrate the ECS signal to the actual head-disk spacing change (i.e., the flying height change), as identifying the peak of the curve is sufficient to accurately identify the IVC operating point.

At block 408, a representation of the IVC operating point is stored within the HDD. For example, the IVC operating point may be stored on a reserved area of a disk 120 (FIG. 1 and FIG. 2), or in the AE module 160 (FIG. 1) or integrated circuit 210 (FIG. 2), or elsewhere within HDD. The IVC operating point value is stored within the HDD so that, according to an embodiment, the IVC operating point voltage can be applied to the slider, or an element embedded in the slider, to negate the natural slider-disk voltage potential, which would otherwise cause an attractive electrostatic force that pulls the slider closer to the disk. According to an alternate embodiment, rather than applying IVC operating point voltage to the slider or an element within the slider, the slider is grounded and the IVC operating point voltage is applied to the disk, to the same effect. By applying an optimal IVC operating point voltage, determined as described herein, the slider reliability is increased by way of inhibiting undesirable effects described herein (e.g., ablation oxidation, lubrication pickup, etc.).

Once the optimum IVC operating point is determined, this information can he used to generate the electrostatic charge on the head slider and, in doing so, the electrons can build up on the slider gradually while avoiding current flow. This gradual charging process is enabled, for example, through use of a relatively high ohm resistor to limit the current while supplying the charge, and/or through use of common mode voltage supply signals.

The described IVC operating point determination scheme can be completed so quickly, in comparison with prior procedures such as the touchdown-pullback method, that it can be performed for each of multiple head-disk interfaces within an HDD, according to an embodiment. Furthermore, in view of its rapidity and its relatively benign nature, according to an embodiment the described IVC operating point determination scheme can be implemented for utilization on a periodic basis throughout the operating lifecycle of an HDD, to recalibrate the IVC system as HDD internal operating conditions change over time. Still further, the rapidity with which this IVC calibration data can be generated and measured also enables application across many different locations on the disk, e.g., spanning the inner diameter, middle diameter, and outer diameter of the disk.

Using touchdown measurements for flying height management or for IVC calibration is a time consuming procedure, has coarse resolving power, and causes the head to come in contact with the disk multiple times, thereby subjecting it to a risk of head wear. Further, because the throughput of the touchdown procedure is relatively slow, it is not practical to perform IVC operating point measurements for each head-disk interface and/or over time to check for changing interface conditions such as lube pickup and/or contamination. By contrast, with the foregoing technique in which spacing signals are used instead of touchdown measurements, this is a non-contact IVC calibration procedure that can be significantly faster (e.g., seconds compared to perhaps up to an hour), even with having a higher resolution (e.g., based on the preamp's supply voltage increment capability).

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A hard-disk drive, comprising:
a head slider comprising a read/write head and an embedded contact sensor (ECS);
a magnetic-recording disk rotatably mounted on a spindle;
a voice coil motor configured to move the head slider to access portions of the magnetic-recording disk; and
an electronic component configured for:
applying a series of input voltages to said head slider,
monitoring a head-disk spacing signal for each of said series of input voltages,
identifying an interface voltage control (IVC) operating point voltage based on the relation between said head-disk spacing signals and said series of input voltages, and
storing a representation of said IVC operating point voltage in said hard-disk drive.

2. The hard-disk drive of claim 1,
wherein monitoring comprises monitoring head-disk spacing signals from said ECS.

3. The hard-disk drive of claim 1,
wherein monitoring comprises monitoring Wallace spacing loss head-disk spacing signals.

4. The hard-disk drive of claim 1,
wherein applying a series of input voltages to said head slider comprises applying a series of input voltages to said ECS.

5. The hard-disk drive of claim 1,
wherein identifying an IVC operating point voltage comprises:
identifying the peak spacing signal value from the relation between said head-disk spacing signals and said series of input voltages; and
identifying the particular input voltage to said head slider that corresponds to said peak spacing signal value.

6. The hard-disk drive of claim 1,
wherein said IVC operating point voltage corresponds to the input voltage required, to negate a natural slider-disk voltage potential which would otherwise cause an attractive electrostatic force that pulls said slider closer to the disk.

7. The hard-disk drive of claim 1,
wherein said electronic component comprises one or more electronic components configured for performing, for a plurality of slider-disk interfaces of said hard-disk drive, said applying, said monitoring, said identifying, and said storing.

8. The hard-disk drive of claim 1,
wherein said electronic component is configured for performing, multiple times over the operational life of said hard-disk drive, said applying, said monitoring, said identifying, and said storing.

9. The hard-disk drive of claim 1,
wherein storing a representation of said IVC operating point voltage comprises storing a plurality of IVC operating point voltages corresponding to different locations on the disk.

10. The hard-disk drive of claim 1,
wherein said monitoring comprises monitoring said head-disk spacing signals without intentionally contacting the head slider with the magnetic-recording disk.

11. An electronic component for use in a hard-disk drive, said electronic component configured for executing one or more sequences of instructions which, when executed, cause performance of:
applying a series of input voltages to a head slider;
monitoring a head-disk spacing signal for each of said series of input voltages,
identifying an interface voltage control (IVC) operating point voltage based on the relation between said head-disk spacing signals and said series of input voltages, and
storing a representation of said IVC operating point voltage in said hard-disk drive.

12. The electronic component of claim 11,
wherein said monitoring comprises monitoring head-disk spacing signals from an embedded contact sensor located in said head slider.

13. The electronic component of claim 11,
wherein said monitoring comprises monitoring Wallace spacing loss head-disk spacing signals.

14. The electronic component of claim 11,
wherein said identifying an IVC operating point voltage comprises:
identifying the peak spacing signal value from the relation between said head-disk spacing signals and said series of input voltages; and
identifying the particular input voltage to said head slider that corresponds to said peak spacing signal value.

15. The electronic component of claim 11,
wherein said IVC operating point voltage corresponds to the input voltage required to negate a natural slider-disk voltage potential which would otherwise cause an attractive electrostatic force that pulls said slider closer to the disk.

16. A method for calibrating an interface voltage control (IVC) system in a hard-disk drive comprising a head slider having an embedded contact sensor (ECS), a magnetic-recording disk rotatably mounted on a spindle, and a voice coil motor configured to move the head slider to access portions of the magnetic-recording disk, the method comprising;
applying a series of input voltages to said head slider,
monitoring a head-disk spacing signal for each of said series of input voltages,
identifying an IVC operating point voltage baaed on the relation between said head-disk, spacing signals and said series of input voltages, and
storing a representation of said IVC operating point voltage in said hard-disk drive.

17. The method of claim 16, further comprising;
applying said IVC operating point voltage to said slider to neutralize a natural slider-disk voltage potential which would otherwise cause an attractive electrostatic force that pulls said slider closer to the disk.

18. The method of claim 16,
wherein said monitoring comprises monitoring based on head-disk spacing signals from an embedded contact sensor located in said head slider.

19. The method of claim 16,
wherein said monitoring comprises monitoring based on Wallace spacing loss head-disk spacing signals.

20. The method of claim 16,
wherein said identifying an IVC operating point voltage comprises:
identifying the peak spacing signal value from the relation between said head-disk spacing signals and said series of input voltages; and
identifying the particular input voltage to said slider that corresponds to said peak spacing signal value.
